(19) United States
(12) Patent Application Publication
(10) Pub. No.: US 2008/0288342 A1
(43) Pub. Date: Nov. 20, 2008

(54) SYSTEM AND METHOD FOR DISPLAYING ADVERTISEMENTS USING A TOOLBAR

(75) Inventor: Vikram V. Ingleshwar, Sholaplur (IN)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/748,305

(22) Filed: May 14, 2007

(51) Int. Cl. G06Q 30/00

(52) U.S. Cl. 705/14

(57) ABSTRACT

Systems and methods have been developed for displaying advertisements within a toolbar. The toolbar display is generated by a toolbar application that searches content displayed within a browser window. For each web page, one or more keywords are selected based on the contents of the web page and an advertisement associated with the selected keywords is obtained. The advertisement, which may be in the form of a hyperlink or user-selectable text or icon, is then displayed within an area of the toolbar display. In this way, toolbars associated with online service providers, such as search toolbars, may be used to actively display advertisements to users in addition to providing convenient, yet passive, access to its associated online service. In order to display the advertisement, the toolbar display may scroll text within the display or may automatically expand the area of the display to show the advertisement or advertisements displayed.

### BACKGROUND

Many online service providers, such as search engines, news and content providers, and application service providers, utilize a business model in which services are given away to Internet users for free. The services are paid for by advertising revenue provided by advertisers who pay the service provider to display advertisements to its users. The service providers, then, have a need to display as many advertisements to their users as possible without interfering with the user's access to the service provided. In addition, as advertising revenue may be tied to the actual effectiveness of an advertisement, service providers also have an incentive to identify and display the most relevant advertisement possible to a user, in a way that the user is less likely to ignore, when displaying advertisements.

### SUMMARY

Against this backdrop systems and methods have been developed for displaying advertisements within a toolbar, such as a toolbar within a browser. The toolbar display is generated by a toolbar application. Via the toolbar application, web pages displayed by the browser are also searched. For each web page, one or more keywords are selected based on the contents of the web page and an advertisement associated with the selected keywords is obtained. The advertisement, which may be in the form of a hyperlink or user-selectable text or icon, is then displayed within an area of the toolbar display. In this way, toolbars associated with online service providers, such as search toolbars, may be used to actively display advertisements to users in addition to providing convenient, yet passive, access to its associated online service. In order to display the advertisement, the toolbar display may scroll text within the display or may automatically expand the area of the display to show the advertisement or advertisements displayed.

One aspect of the disclosure is a method for displaying advertisements in a browser window generated by a browser on a computing device. The method includes detecting a command to the browser to retrieve a first web page and display contents of the first web page within a first area of the browser window. The contents of the first web page are, or have previously been, searched in order to determine what the general subject matter of the web page is. Using the results of the search, a request is transmitted to an advertisement server for an advertisement associated with the contents of the first web page. An advertisement is selected and transmitted to the computing device with the browser. The advertisement is received and displayed in a toolbar display within a second area of the browser window.

The disclosure further describes a system for displaying advertisements within a browser window. The system includes a browser application that retrieves source code and displays web pages within the browser window and a toolbar application that generates a toolbar display within the browser window, wherein the toolbar application also searches retrieved source code and, based on the search, selects and transmits keywords to an advertisement server. In addition, the toolbar application further receives advertisements associated with the keywords and displays the advertisements within the toolbar display.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates an embodiment of a computing architecture for displaying advertisements via a toolbar.

FIG. 2 illustrates a toolbar display with an advertisement area that can display an advertisement within the area.

FIG. 3 illustrates a toolbar display with an advertisement area that, upon receipt of advertisements, can display the advertisements within a drop down box that dynamically extends beyond the original area of the toolbar display.

FIG. 4 illustrates yet another embodiment of a toolbar display with an advertisement area.

FIG. 5 illustrates yet another embodiment of a toolbar display with an advertisement area.

FIG. 6 illustrates an embodiment of a high-level method for displaying advertisements in a browser window generated by a browser.

FIG. 7 illustrates another embodiment of a method for displaying advertisements in a browser window generated by a browser.

FIG. 8 illustrates an embodiment of a GUI presented to a user upon selection of the “Customize” option in FIG. 7.

FIG. 9 illustrates an embodiment of browser GUI including an embodiment of a toolbar display area as described herein.

### DETAILED DESCRIPTION

A web browser is a software application that enables a user to display and interact with text, images, and other information typically located on a web page at a website on the World Wide Web or a local area network. Web pages are well known in the art, the term referring to a data structure containing information that may be interpreted by a browser to create a display of media content to a user. Web pages may include or identify text, images and other content to be displayed as well as substantial formatting information used by the browser when creating the display showing the content. The text and images displayed may be associated with information linking them to other web pages at the same or a different website. Web browsers allow a user to quickly and easily access information provided on many web pages at many websites by traversing these links.

Some of the web browsers available for personal computers include INTERNET EXPLORER, MOZILLA FIREFOX, SAFARI, NETSCAPE, and OPERA. Web browsers are the most commonly used type of HTTP user agent. Although browsers are typically used to access the World Wide Web, they can also be used to access information provided by web servers in private networks or content in file systems.

In a graphical user interface on a computer monitor, a toolbar is a row, column, or block of onscreen user-selectable buttons or icons that, when selected, activate certain functions of an application. Toolbars are a commonly used element in a graphical user interface for software applications, including browsers. Toolbars are seen in common applications such as MICROSOFT WORD.

Another use of toolbars is as add-ons for web browsers through which users may access functions of a remote software application or web service. For example, toolbars are commonly used to provide quick access to remote web search engines such at that provided by YAHOO!. Such toolbars are referred to as add-ons because they are not an integral part of the browser, but rather an independent software toolbar application that must often be separately obtained and installed on the computer. Such toolbar applications are designed to be executed whenever the browser is initiated, so that whenever the browser window is displayed the toolbar application generates the toolbar display within the browser window. Thus, the toolbar display is visible regardless of the content being displayed as the browser user “surfs” the network. In addition, the toolbar application remains active while the browser is active and controls the operation of the toolbar and its interactions with its associated remote software application or service in response to user commands directed to the toolbar.

Systems and methods are disclosed herein for displaying advertisements within a toolbar, such as a toolbar within a browser. The toolbar is generated by a toolbar application that is also adapted to search web pages displayed by the browser. For each web page, the toolbar application selects one or more keywords based on the contents of the web page and obtains an advertisement associated with the selected keywords. The advertisement, which may be in the form of a hyperlink or user-selectable element such as text element or icon, is then displayed within an area of the toolbar display. In this way, toolbars associated with online service providers, such as search toolbars, may be used to actively display advertisements to users in addition to providing convenient, yet passive, access to its associated online service. In order to display the advertisement, the toolbar display may scroll text within the display or may automatically expand the area of the display to show the advertisement or advertisements displayed.

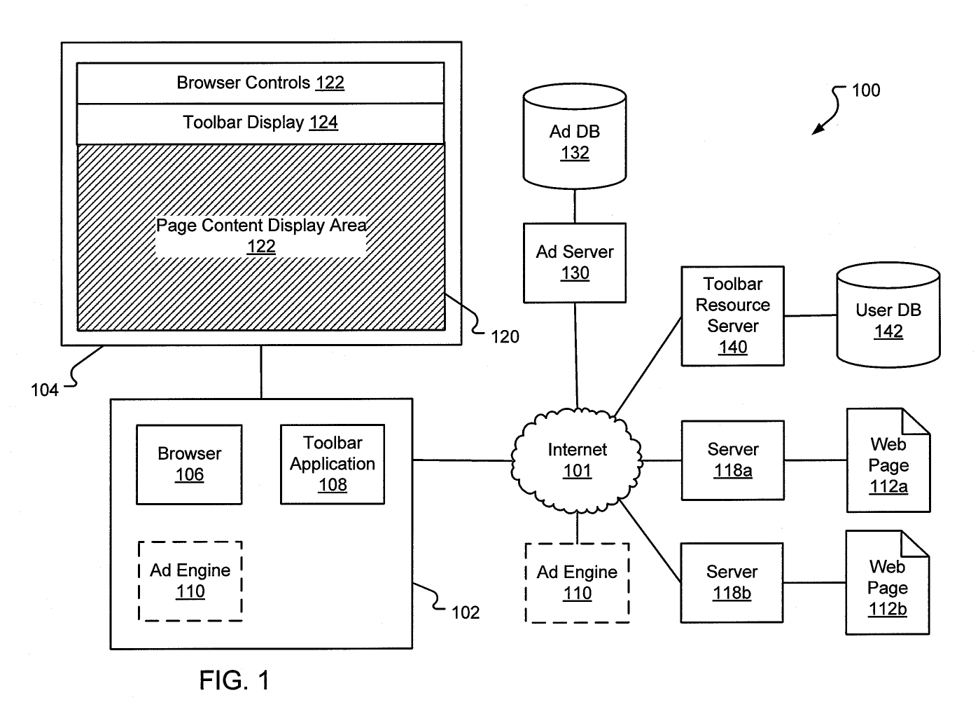

FIG. 1 illustrates an embodiment of a computing architecture for displaying advertisements via a toolbar. The architecture 100 is a computing architecture in which a browser application on a computing device 102 creates a browser window 120 on a display 104. The architecture 100 illustrated is a networked client/server architecture in which a computing device (referred to as a “client”) issues web page requests to a remote computing device (referred to as a “server”), which responds by transmitting the requested web page to the client for rendering to a user. The systems and methods described herein are suitable for use with other architectures as discussed in greater detail below.

For the purposes of this disclosure, a computing device such as the client 102 or server 118 includes a processor and memory for storing and executing data and software. Computing devices may be provided with operating systems that allow the execution of software applications in order to manipulate data. In the embodiment shown, the client 102 is a computing device, such as a personal computer (PC), web-enabled personal data assistant (PDA) a smart phone, or a laptop computer. The client 102 is connected to the Internet 101 via a wired data connection or wireless connection such as a wi-fi network, a WiMAX (802.16) network, a satellite network or cellular telephone network.

The client 102, in the embodiment shown, includes a browser 106 as discussed above. The browser 106 allows a user to input a web page identifier, such as a uniform resource locator (URL), a uniform resource identifier (URI), or a network address, or otherwise allow a user to issue commands that identify a web page 112a, 112b to the browser 106. In response, the browser 106 retrieves the web page 112a, 112b and displays it in the browser window 120. In an embodiment, retrieval includes transmitting a request for the web page 112a, 112b via the network 101 to the appropriate server 118a, 118b as determined by the web page identifier. As is well known in the art, a web page identifier may identify a pre-existing data structure, such as a file stored on a server 118a, 118b. Alternatively, a request for the web page identified by a web page identifier may be interpreted by the server 118a, 118b to generate the web page 112a, 112b on demand and transmit it to the requester.

In the embodiment shown, the browser 106 is a software application that, when executed, generates a browser window 120 on a display 104 attached to or part of the computing device 102. The browser window 120 includes a set of user-selectable controls 122, which may or may not be displayed in the form of a toolbar, through which the user of the client device 102 can interact to control the operation of the browser 106. For example, the controls 122 may include a button control for each of the forward-back-refresh-stop-home commands commonly associated with the rendering of web pages by browsers. By selection of these controls, the user may cause the browser 106 to transmit requests for and thereby retrieve web pages 112a, 112b from media servers 118a, 118b. The source code of the web pages 112a, 112b are then interpreted by the browser 106 to generate the content displayed in the content display area 122 of the browser window 120.

The browser window 120 further includes at least one toolbar display area 124 that may be used for displaying advertisements when the browser 106 is displaying a web page to the user. In an embodiment, the toolbar display area 124 is generated by the toolbar application 108. The toolbar application 108 is an independent application adapted to work with the browser 106 and generate the toolbar display 124 independently from the operation of the browser 106. As discussed in greater detail below, the toolbar display application 108 monitors the operation of browser 106 and, in response, obtains and displays advertisements in the toolbar display 124 that are relevant to the contents currently displayed in the page content display area 122.

In an embodiment, the toolbar application 108 is a locally executing software module. The toolbar application 108 may be adapted to provide an interface that allows quick access to a resource located on a remote resource server 140. For example, in an embodiment, the toolbar application 108 displays a toolbar display 124 that allows users to input search terms and initiate an internet search performed by the toolbar resource server 140. A search service is but one example of a service that could be accessed via the toolbar display 124, and the systems and methods described herein could be adapted to any remote service. Alternatively, the toolbar application 108 may be adapted to provide access to a resource on the client 102.

In the embodiment shown, the toolbar display 124 is located below the browser controls 122. However, the toolbar display 124 could be placed within the browser window 120 in any location, e.g., located at the bottom of the browser window 120, on either side of the window 120, as a box within the window or above the browser controls 122, as long as the browser 106 can accommodate the placement.

The architecture 100 also includes one or more servers 118 (in the embodiment shown, two servers 118a, 118b are illustrated) as are known in the art. Each server 118 may be a single server or a group of servers acting together. A number of program modules and data files may be stored in a mass storage device and RAM of the server 118, including an operating system suitable for controlling the operation of a networked server computer, such as the WINDOWS XP or WINDOWS 2003 operating systems from MICROSOFT CORPORATION.

Local data structures, including discrete web pages such as .HTML files, may be stored on a mass storage device (not shown) that is connected to, or part of, any of the computing devices described herein including the client 102 or a server 118. The mass storage device includes some form of computer-readable media and provides non-volatile storage of data for later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In the architecture 100 shown, the client 102 is connected to one or more servers 118a, 118b via a network, such as the Internet 101 as shown. The client 102 is adapted to issue requests to the server computers 118 for media content such as web pages 112a, 112b. In response, the server computer 118a, 118b with the requested content retrieves or otherwise accesses the content and transmits the content back to the requesting client 102. The requested media content may be stored as a discrete media object (e.g., a file containing renderable media data that conforms to some known data format) that is accessible to the server 118. The requested content may be stored on the particular server 118, or may be stored in a remote mass storage device (not shown) to which the server 118 has access. In an alternative embodiment, the requested media content may be generated by the server 118 in response to the request.

The client 102, upon receipt of the requested media content, may store the media content for later rendering. Alternatively, the client 102 may render the media content as quickly as practicable while the content is being received in order to reduce the delay between the client request for the content and the initiation of the rendering of the content to the user—a practice referred to as rendering “streaming media.” When rendering streaming media, the client 102 may or may not store a local copy of the received media content depending on the system.

In an embodiment, the toolbar application 108 monitors the operation of the browser 106 to determine what content is being displayed. If the content is a web page 112 containing text or other data or information that can be associated with one or more keywords, the application 108 retrieves and displays an advertisement associated with the keyword(s) as described below.

In the embodiment shown, the keywords are generated by an advertisement engine 110. As described in greater detail below, the advertisement engine 110 may search the text or other portions of the source code of a web page 112 to identify one or more keywords describing the content of the web page 112.

The keywords may be selected based on the number of times they occur within the content or their location. Furthermore, metadata such as title information, content descriptions, author or category information (e.g., entertainment, news, movie reviews, etc.) may also be used to generate a keyword. Keywords may also be selected from information known about the user, such as through a user identifier associated with the toolbar application 108, a cookie located on the client 102, or some other means.

For example, a web page containing a review of the latest model FORD pickup truck's suitability for drawing a horse trailer could be searched and it would be determined that the web page 112 is likely described by such keywords as “FORD”, “automobile”, “pickup truck”, “horse”, and “trailer”.

In addition, the toolbar application 108 may be associated with a user identifier and that identifier may be used to obtain information from a user database 142 such as the user's demographic information, past purchase history and user interests. The user database 142 may be located on or accessible via the remote server 140 associated with the toolbar application 108. For example, in an embodiment the user database includes information on users that have become members of the service provided by the toolbar resource server 140. Alternatively, the user database 142 may be stored locally or located on a different server or location accessible by the network 101. Some user information could also be generated based on the network address of the client 102 and the transmission route of the communications between the client 102 and the advertisement engine 110.

In order to search the requested web page 112, the advertisement engine 110 may inspect a copy of the source code of the web page 112. This may include retrieving an additional copy of the requested web page 112 (for example, if the advertisement engine 110 is remote from the client 102) or may include searching the copy of the web page received by the browser 106 on the client 102.

In the example provided above, keywords may also be obtained from the user database such as a keyword associated with the user's income level, a keyword identifying a recent retailer through which the user made purchases, or a keyword identifying the user's location. Thus, in addition to “FORD”, “automobile”, “pickup truck”, “horse”, and “trailer”, the advertisement engine may also generate the keywords “wealthy”, “SAKS FIFTH AVENUE” and “Kentucky”.

The advertisement engine 110 may be a standalone module executing locally on the client 102 or may be a remote resource executing on a remote server (as illustrated by the dashed lines). Other architectures are also possible such as, for example, an embodiment in which the functions of the advertisement engine 110 are incorporated within the toolbar application 108 or incorporated within the services provided by the advertisement server 130.

The keyword(s) generated by the advertising engine 110 are then transmitted to an advertisement server 130 in an advertisement request. In the embodiment shown, the advertisement server 130 is provided with an advertisement database 132 containing a set of advertisements. In an embodiment, the advertisements have been previously associated with keywords. The advertisement server 130 selects an advertisement based on the keywords provided. In performing the selection, the advertisement server 130 may perform a simple keyword matching algorithm to select an advertisement. Alternatively, the server 130 may perform more complex analyses to determine which of the advertisements in the advertisement database 132 should be selected based on all of the keywords provided as well as other criteria known to the advertisement server 130.

Regardless of the analyses performed, the advertisement server 130 selects an advertisement based on the keywords and transmits the advertisement back to the toolbar application 108. To continue the example provided above, in response to the “FORD”, “automobile”, “pickup truck”, “horse”, “trailer”, “wealthy”, “SAKS FIFTH AVENUE” and “Kentucky” keywords, the advertisement engine 110 may select an advertisement for a luxury equestrian clothing line based on the “horse” and “wealthy” keywords, an advertisement for a condominium for the Kentucky Derby horse race “horse”, “Kentucky” and “wealthy” keywords, or an advertisement for SAKS FIFTH AVENUE or a competitor based on the “wealthy”, “SAKS FIFTH AVENUE” keywords.

The toolbar application 108 receives the advertisement, either directly from the advertisement server 130 or via the advertisement engine 110, and then revises a portion of the toolbar display 124 to display the advertisement to the user. As the toolbar application 108 is independent of the browser 106, the advertisement is displayed without any additional actions taken by the browser 106 related to advertisements. In addition, the advertisements displayed are contextually relevant to the content being displayed on the web page and therefore more likely to be of interest to the user.

In addition, for each web page rendered by the browser 106, several advertisements could be displayed over the elapsed time of rendering the media object. For example, the application 108 may request, or be automatically sent, a new advertisement selected based on the keywords for the web page every so often, such as every minute or every 10 seconds, based on a refresh setting. The newly received advertisement may then be used to replace the existing advertisement even though the user has not interacted with the browser 106 in that time period.

FIG. 1 presents one embodiment a client/server architecture. Many other embodiments are also possible, including different client/server embodiments in which various functions are performed by different components or distributed between several components. For example, in an embodiment the client 102 may be rendering web pages stored locally on the client. However, the client 102 may still transmit a request for an advertisement to an advertisement server 130 so that the user experience is identical to that described above. In yet another embodiment, the advertisement engine 110 may be located on the independent advertisement server 130. The media server 118 may then transmit requests to the advertisement server 130 for advertisements when a web page is requested by the client 102. If the client 102 is not equipped with the toolbar application 108, then the advertisements may simply be ignored. However, if the toolbar application 108 is on the client 102, then the advertisements may be received and displayed on the toolbar display 124. These requests may include the keywords to be used for selecting the advertisements, a copy of the web page or simply an identification of the web page, in which case the ad server 130 will perform the function of generating the keywords in addition to the advertisement selection itself. Many other combinations and embodiments are also possible in which more or less functions are performed by different devices, while still providing the same experience to the user.

The advertisements transmitted and displayed to the client 102 may be tracked by one or more of the modules described above. For example, in an embodiment, the toolbar application 108 may track what advertisements are displayed to the user and return this information to a central server, such as the toolbar resource server 140 so that the advertiser may be billed for the advertisement placement by the toolbar resource operator. In an alternative embodiment, the advertisements may be tracked by the advertisement server 130 and revenue obtained and distributed by that system. In yet another embodiment, notification of advertisement placements may be transmitted from the advertisement to the operators or owners of the web page and revenue shared with them also.

Regardless of which module performs the tracking, notification and billing functions, the advertisers are billed for the display of their advertisement. The revenue from the display of the advertisements may then be used to support the service provided by the toolbar application.

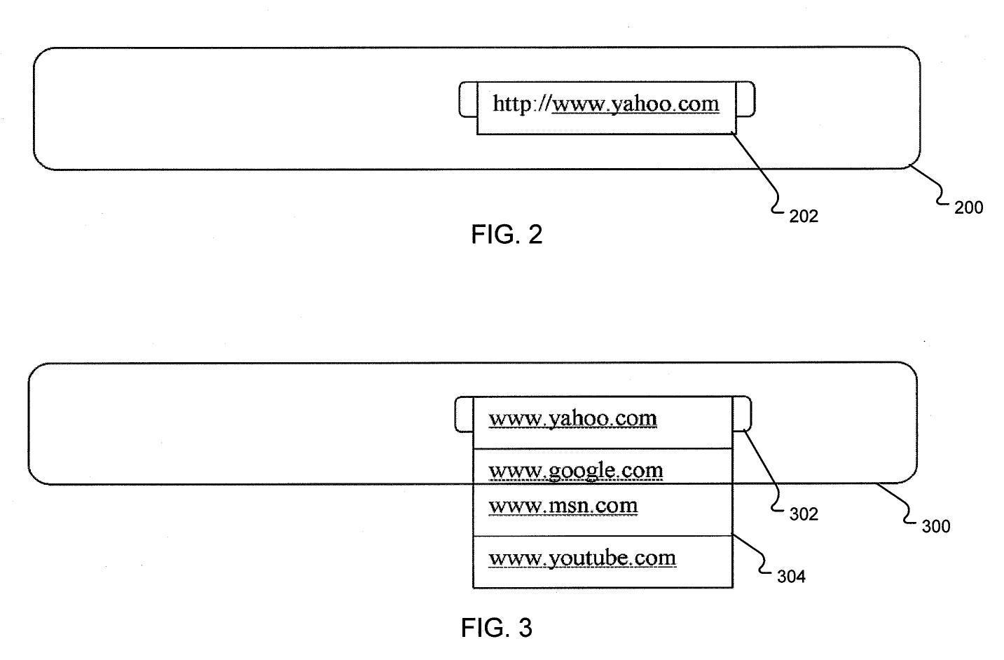

FIGS. 2-5 illustrate different embodiments of toolbar displays with advertisements that may be rendered to a user. As discussed above, the primary purpose of the toolbar application may be to provide quick access to a remote resource, such as a search utility, an email utility, a database, or some other utility. To perform this function, the toolbar display may include one or more user-selectable controls as shown for accessing the remote service. In the embodiments illustrated, the toolbar display is associated with a remote search service provided by a toolbar resource server, such as those provided by a web search portal. The toolbar display may include one or more controls (not shown) for directly inputting search terms and initiating a search request with the associated service. Such controls may include a text box for entering search terms and a button or other control for transmitting the search terms to the toolbar resource server. In an embodiment, whenever the user is not interacting with the client (e.g., the mouse is not moving), the controls related to the remote service may be removed and replaced with the advertisement area. When a user moves a mouse or otherwise interacts with the client (e.g., by mousing over or otherwise selecting the toolbar display), the advertisements may be removed and the controls reappear. This maximizes the use of the toolbar display area for advertising while not changing its functionality.

FIG. 2 illustrates a toolbar display 200 with an advertisement area 202 that can display an advertisement within the area 202. In an embodiment, the advertisement may be text or alternatively may be an icon or graphic adapted to fit within the area 202. In the embodiment shown, the advertisement is in the form of hyperlinked text (i.e., text that when selected causes the browser to request a web page or file associated with the text). Various dynamic effects may also be applied, such as for example scrolling the advertisement text through the advertisement area 202, having the advertisement fade in, blink, or otherwise dynamically change in order to draw the attention of the user.

FIG. 3 illustrates a toolbar display 300 with an advertisement area 302 that, upon receipt of advertisements, can display the advertisements within a drop down box 304 that dynamically extends beyond the original area of the toolbar display 300. The drop down box 304 may persist or may be removed after a predetermined period of time.

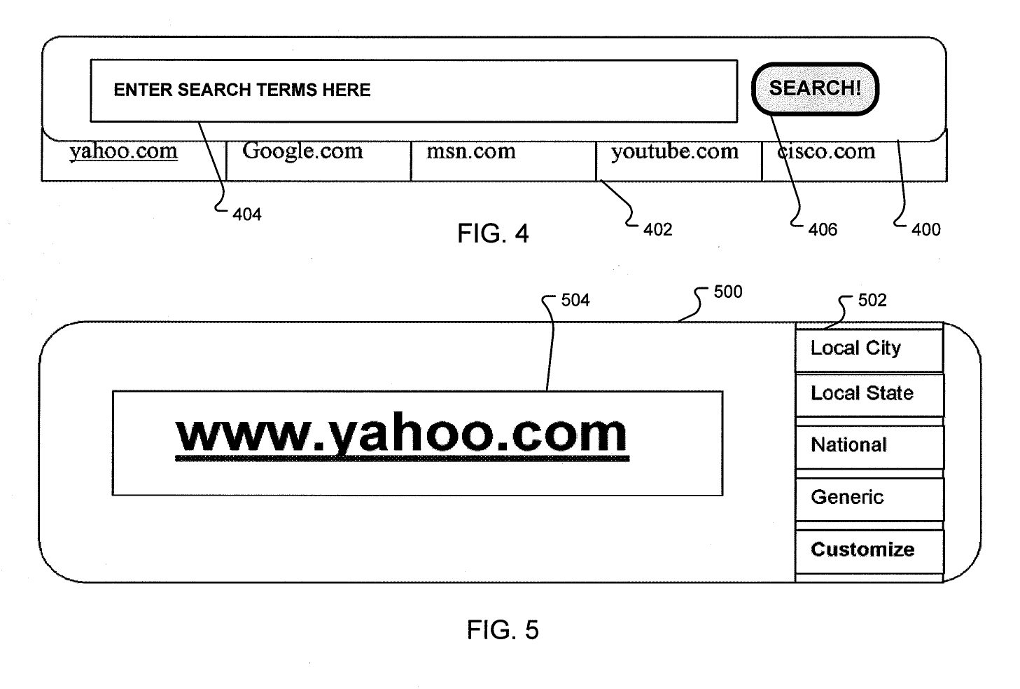

FIG. 4 illustrates yet another embodiment of a toolbar display 400 with an advertisement area 402. In the embodiment shown, advertisements are displayed in an extension area 402 that extends, in this case drops down, from the display 400. The extension area 402 displays one or more advertisements simultaneously and may persist or may be removed after a predetermined period of time. FIG. 4 also illustrates some user-selectable controls for accessing the search service associated with the toolbar application. A first control in the form of a textbox 404 is provided into which a user may enter text information. A second control in the form of a user-selectable button 406 is provided that allows the user to transmit a search request containing the search terms directly to the search service without first accessing the search service's web portal.

FIG. 5 illustrates yet another embodiment of a toolbar display 500 with an advertisement area 502. In the embodiment shown, the advertisement area 504 displays an advertisement. In addition, a control area 502 is provided to allow the user to refine what advertisements are displayed. The control area 502 is divided into segments, in this case user-selectable buttons or hyperlinked linked text, for displaying advertisements associated with different categories. In the embodiment shown, advertisements are divided into the categories “Local City”, “Local State”, “National”, “Generic” and “Customize”. User selection of a particular segment will result in the display of the associated advertisement or advertisements. For example, the Local City category may include advertisements that are both associated with the keywords of the web page being displayed and the keyword corresponding to the user's city.

The Customize segment allows users to enter information to be used in selecting advertisements by the advertisement server. In an embodiment, the user can select from a predetermined set of advertisement categories such as Auto, Health, Education, Jobs and Entertainment. Alternatively, the user may enter additional criteria in the form of keywords or complete a questionnaire identifying the user's interests to the toolbar application. This user-generated information may be included in the advertisement request as an added limitation on advertisements whenever the toolbar application transmits such a request. For example, in an embodiment, the user-generated information is transmitted as an additional keyword to be included with the keywords derived from the web page.

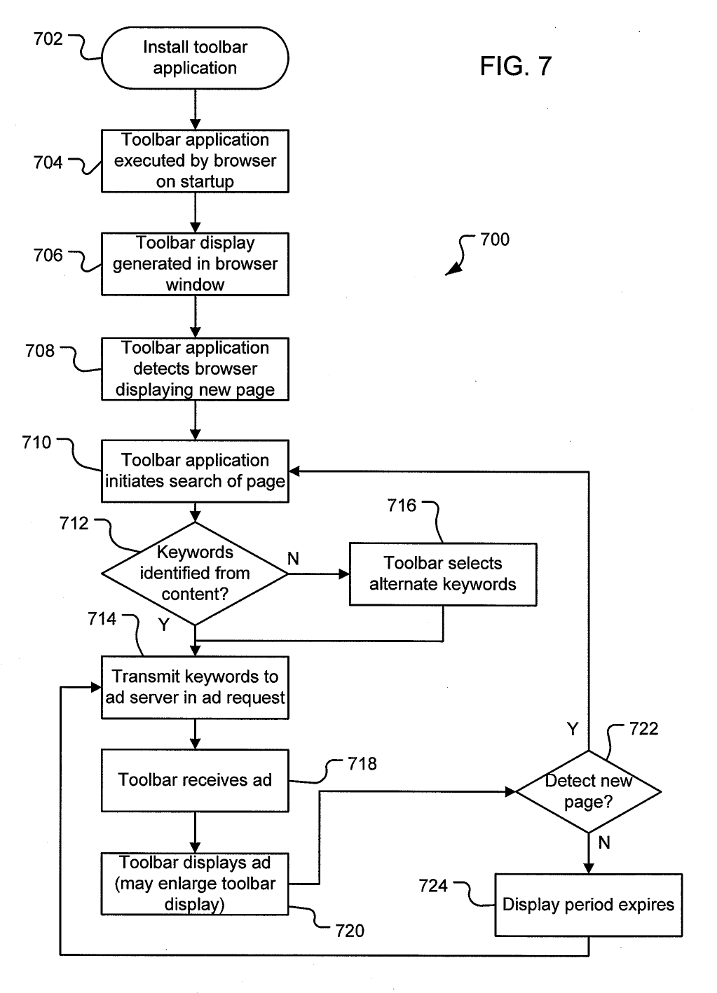

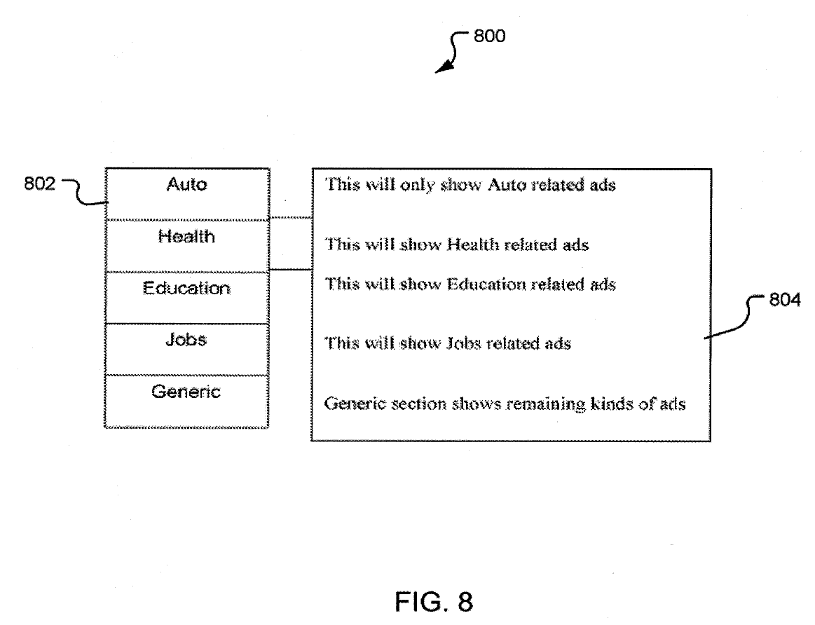

FIG. 8 illustrates an embodiment of a GUI 800 presented to a user upon selection of the “Customize” segment in FIG. 7. The GUI 800 shown is divided into two areas: a category area 802 listing a set of categories; and a explanatory area 804 in which the results of selection of the associated category are described. The through this GUI 800, the user can select to preferably receive advertisements that fall within a particular category. In the embodiment shown, the advertisement categories listed include Auto, Health, Education, Jobs and Generic. Each category in the category area 802 may be associated with a user-selectable button, hyperlink, check box or other control element.

User-selection may result in a storing of the advertisement category selection information on the client, that information then may be submitted with each subsequent request for an advertisement. Alternatively or in addition to local storage, the advertisement category selection information may be transmitted to one of the remote devices, such as the toolbar resource server or the advertisement server, for use in subsequent advertisement requests.

The advertisement category selection information may be a keyword, a category identifier or some other code or indicator that is usable to limit the set of advertisements from which the advertisement server will select advertisements for the user. The advertisement category selection information may be directly usable by the advertisement server or may need to be interpreted by an intermediate system, such as the toolbar resource server or the advertisement engine prior to communication of the category selection to the advertisement server.

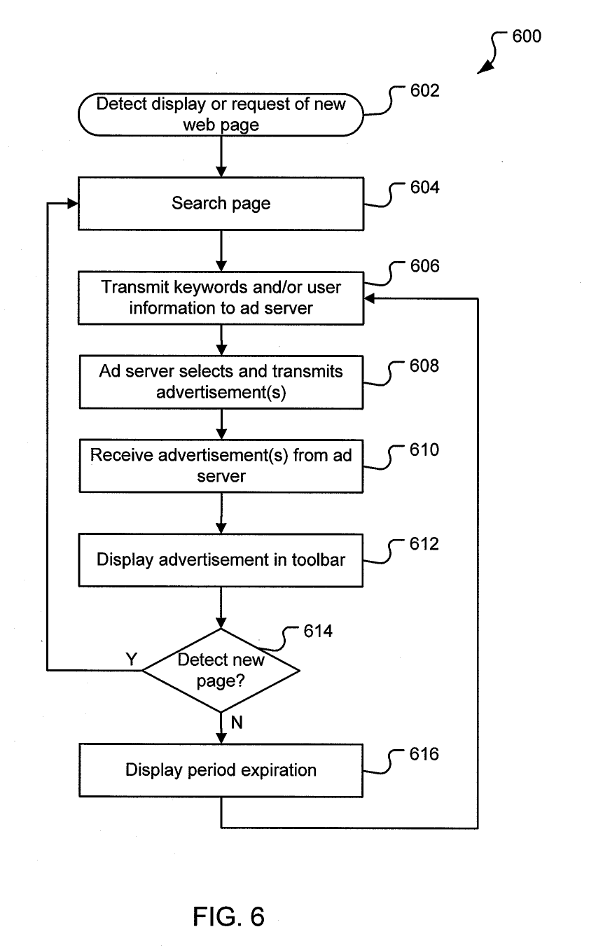

FIG. 6 illustrates an embodiment of a high-level method for displaying advertisements in a browser window generated by a browser. In the embodiment shown, the method 600 begins with a detection operation 602 in which the toolbar application becomes aware that the browser is to display a new web page in its window. In an embodiment, the detection operation 602 may occur when the toolbar application detects that a command has been issued to the browser to retrieve and display a particular web page, such as by detecting a user selection of hyperlinked text or the entry of a web page address into an address bar and a user command to retrieve the web page for the address. Alternatively, the detection operation 602 could occur when a new web page has been retrieved by the browser and is displayed to the user.

The detection operation 602 may occur before or after executing the browser. For example, the detection operation 602 may occur as the result of a user action that causes the browser to be executed and a web page retrieved. Thus, the detection operation 602 may occur before a browser window has been created by the browser or after, such as when a user is surfing through web pages. As part of generating the browser window, the toolbar application is executed and generates a toolbar display within the browser window. This toolbar display may be initially generated upon startup of the browser, but is revised periodically, such as when an advertisement is received or as part of the display advertisement operation 612. If the toolbar application is not active upon detection of the new web page, it may be executed as necessary to perform the various functions described herein.

After the detection operation 602, the contents of the first web page are searched in a searching operation 604. In an embodiment, the searching operation 604 may include searching the local copy of the web page retrieved by the browser. Alternatively, the operation 604 may include transmitting the web page's address or other identification information to a remote system, such as a remote advertisement engine or advertisement server as discussed above, so that the remote system can search the web page. For example, in an embodiment the toolbar application can send an identifier, such as a network address (e.g., a URL), of each web page requested by a browser to it's associated toolbar resource server. The resource server may then pass the address to an advertisement engine that then retrieves its own copy of the requested web page and searches the contents. Alternatively, the resource server may retrieve its own copy or a database of keywords already associated with the web page developed from a previous search.

The searching operation 602 may generate a set of one or more keywords derived from the content of the web page including the content that is not actually displayed when the web page is displayed by the browser in the browser window. For example, one or more keywords may be independently selected from a title element, a description element, or a body text element of the web page. Such non-displayed content includes metadata, formatting, title, and other data provided by the web page author. In an embodiment, the non-displayed information may include information specifically directed to the advertisement server for use in selecting an advertisement. Keywords may also be selected from the text of the displayed content.

Based on the results of the search, a request is transmitted to an advertisement server in a transmit ad request operation 606. In the operation 606, a request for an advertisement associated with the contents of the first web page is generated and transmitted. The request may include keywords identified from the content in the search operation 604 as well as other information such as that associated with the client, the user and any metadata known to be associated with the web page from sources other than the web page itself.

The advertisement server then selects one or more advertisements and transmits in an advertisement transmission operation 608. The advertisement server may transmit the advertisement(s) to the client directly or to the some other remote system such as the toolbar resource server or the advertisement engine. If transmitted to a remote system, the advertisements are forwarded to the toolbar application on the client. Regardless, the advertisements are received by the recipient in a receive advertisement operation 610.

After receiving the advertisement(s), the advertisement(s) are displayed on the toolbar display in a display advertisement operation 612 as described above. This may include regenerating or otherwise redrawing the toolbar display. Depending on the embodiment, for example that shown in FIG. 3, the toolbar display may be enlarged to show the advertisement(s) received.

In an embodiment, the display advertisement operation 612 may be delayed after the detection for a predetermined period of time. This delay may include delaying the search operation 604 by delaying the initial request from the toolbar application for a new advertisement until a predetermined period of time has passed. This embodiment avoids retrieving advertisements for web pages that a user views only temporarily, i.e., less than a some amount of time as designated by the predetermined period of time from the detection operation 602.

In the embodiment shown, the advertisement is displayed until another new web page request is detected or a predetermined display period expires, as illustrated by the determination operation 614. If a new page request is detected, the search operation 604 and following operations are repeated for the newly detected web page.

If no new page request is detected, then upon display period expiration (operation 616) the transmit advertisement request operation 606 and the method 600 continues from that point as described above. In an alternative embodiment (not shown), if multiple advertisements were received by the toolbar application in the receive advertisement operation 610, upon expiration of the time period a different one of the previously transmitted advertisement may be displayed, thus allowing the toolbar application to ultimately cycle through display of all of the received advertisements in the event that they are not all shown simultaneously on the display.

FIG. 7 illustrates another embodiment of a method for displaying advertisements in a browser window generated by a browser. In the embodiment shown, the method 700 begins with a user installing the independent toolbar application in an installation operation 702. Subsequent to the installation operation, every time the browser is executed to render a browser window in order to view a web page or other document, the toolbar application is also executed in an execution operation 704. The toolbar application with then generate a toolbar display in some area within the browser window in a generate toolbar display operation 706.

In detection operation 708, the toolbar application detects that the browser is displaying or has been directed to retrieve and display a new web page. In response, the toolbar application initiates a search of the new web page in an search initiation operation 710. As discussed above, the search initiation may include transmitting a search request for keywords to a remote system or transmitting a request for an advertisement for the web page to a remote system. In either case, the search is performed.

A determination operation 712 is then performed to determine if any keywords are identified. If keywords can be identified from the contents of the web page or from information known about the web page, then the keywords are transmitted to the advertisement server in a keyword transmission operation 714. However, if no keywords can be identified from the contents of the web page, keywords are selected based on an alternative criteria in a select alternate keywords operation 716 and the alternate keywords are transmitted in the keyword transmission operation 714. In an embodiment, alternate keywords may be selected based on information known about the user or about the user's computer.

Advertisement(s) are then received from the advertisement server in a receive advertisement operation 718. The toolbar application then displays the advertisement in the toolbar display in a display operation 720.

If there is a subsequent detection of a new page request by the browser within a predetermined period of time as shown in determination operation 722, operational flow returns to the search operation 710. However, if the display period expires (display period expiration operation 724), the method 700 requests a new advertisement by repeating the keyword transmission operation 714 using the previously identified keywords. Depending on the advertisement server, the same or different advertisements may be returned in response to subsequent advertisement requests.

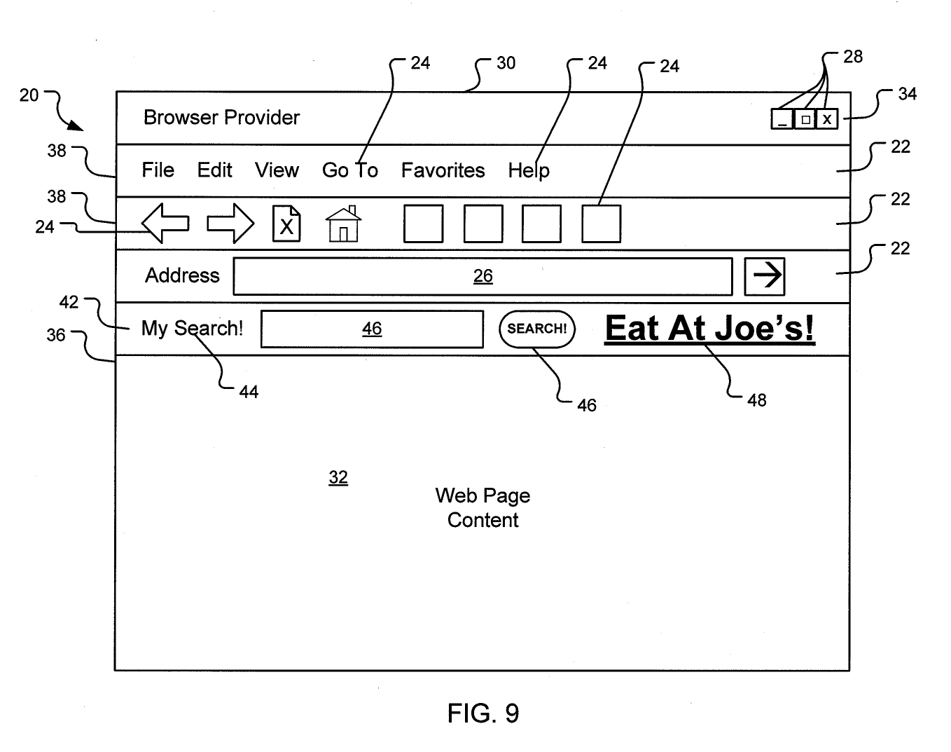

FIG. 9 illustrates an embodiment of browser interface 20 having a plurality of windows, each providing various functionality to the Internet user, including an embodiment of a toolbar display area as described herein. The browser interface 20 may comprise a first parent window 30 that typically defines the general size, color, and layout of the browser interface and includes window control buttons 28 (e.g., minimize, close, etc.) for that window 30. The browser interface 20 may also comprise a second parent window 36 (a child to the first parent window) within the first parent window 30, and one or more child windows 38 dependent from the second parent. The second parent window 36 and child windows 38 typically define information and/or functionality that will assist an Internet user when accessing and navigating the Internet.

For example, the second parent 36 and its dependent windows 38 may provide toolbars, pull-down menus, Plug-ins, applications, etc. For example, three windows 38 provided at the top (in the drawing) of the interface 20 define three toolbars 22, which may include a variety of interface controls 24 such as, for example, pull-down menus, functional buttons (e.g., stop, back, forward, home, etc.), and a combination of functional buttons and windows (e.g., a search button and window). The uppermost toolbar 22 provides a plurality of pull-down menus 24; the middle toolbar 22 provides a plurality of functional buttons 24; and the lowermost toolbar 22 provides a pull-down menu and a textbox element 26 (for entering URL addresses). A content window 32 is also provided as part of the interface 20 within which content from an Internet content provider such as web pages may be displayed. In an embodiment, the browser user may toggle any of the lower three (in the drawing) toolbars 22 on and off using a View toolbar object 24 (pull-down menu) provided in the second toolbar 22.

The interface of FIG. 9 also includes a toolbar display 42 provided by a toolbar application as described above. For example, the toolbar display 42 may be defined by the ActiveX control or Plug-in or other type of application. In the embodiment shown, the toolbar 42 includes a resource identifier 44 that identifies the remote service that is accessed via the toolbar 42. In the embodiment shown, the remote service is a search service and, next to the identifier 44, the toolbar includes a textbox 46 for entering search terms that are transmitted directly to the remote service upon user selection of a execute button control 46. Depending on the nature of the remote service accessed via the toolbar 42, different, fewer or more interface elements may be provided. Such interface elements may comprise virtually any type of information and/or functionality available via a browser. Thus, by way of non-limiting example, an interface element may comprise a pull-down menu, a toolbar and a pull-down menu, textual information, textual, aural, and/or graphical (animated or not) information, video, video and audio, audio, etc.

In addition, the toolbar 42 includes an advertisement 48 selected based on the content displayed in the content window 32. The advertisement 48 may be selected using any of the methods or processes described above. The advertisement 48 may be an interface element, such as a pull-down menu, a hyperlink providing access to a network access associated with the advertisement or may be a simple text or image advertisement, such as a corporate logo.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present invention. For example, the systems and methods described are not limited to display of web pages, but could also be used for rendering any media content regardless of its type within a browser or other window. For example, a browser displaying video could also be displaying advertisements via the toolbar application selected based on information contained within the video or as part of the video's metadata. Such advertisements are displayed without modification of either the browser, its associated media player or the video.

Numerous other changes may be made which will readily suggest themselves to those skilled in the art and which are encompassed in the spirit of the invention disclosed and as defined in the appended claims.

1. A method for displaying advertisements in a browser window generated by a browser the method comprising:
detecting a command to the browser to retrieve a first web page and display contents of the first web page of the browser window, the command causing the browser to retrieve and display the first web page in a first area of the browser window;
searching the contents of the first web page;
transmitting a request to an advertisement server for an advertisement associated with the contents of the first web page;
receiving a first advertisement from the advertisement server in response to the request; and
displaying the received first advertisement in a toolbar display within a second area of the browser window.

2. The method of claim 1 further comprising:
selecting, from the contents of the web page, one or more keywords; and
transmitting a request to an advertisement server for an advertisement associated with the selected one or more keywords.

3. The method of claim 2 further comprising:
generating a toolbar display within the browser window, the toolbar display providing access to a remote service associated with the toolbar display;

4. The method of claim 1 wherein the first web page is identified by an address on a network and searching further comprises:
transmitting the address of the first web page to an advertisement engine; and
retrieving, by the advertisement engine independent of the browser, a copy of the first web page from the address.

5. The method of claim 2 wherein each of the one or more keywords is independently selected from a title element, a description element, or a body text element of the first web page and searching further comprises:
searching a source code for the first web page from which the browser displays the first web page.

6. The method of claim 1 further comprising:
determining, based on the search of the first web page, that keywords describing the contents of the first web page are not identifiable; and
selecting keywords describing a user associated with the browser.

7. The method of claim 6 wherein each of the one or more keywords is independently selected from a user identifier assigned to the toolbar application, a location identifier associated with the browser or a location identifier generated as part of transmitting the request.

8. The method of claim 1 wherein displaying further comprises:
enlarging the second area to fit the first advertisement.

9. The method of claim 1 wherein displaying further comprises:
scrolling text associated with the first advertisement within the toolbar display.

10. The method of claim 1 wherein the advertisement includes a link to a second web page associated with the first advertisement and displaying further comprises;
displaying a user-selectable element that, upon selection, causes the browser to retrieve and display the second web page.

11. The method of claim 1 further comprising:
after display of the first web page in the first area of the browser window, detecting a command to the browser to retrieve a third web page and display contents of the third web page within the first area of the browser window;
searching the contents of the third web page;
transmitting a request to an advertisement server for an advertisement associated with the contents of the third web page;
receiving a second advertisement from the advertisement server in response to the request; and
displaying the second advertisement in the toolbar display.

12. The method of claim 1 further comprising:
after displaying the first advertisement for a predetermined period of time, transmitting a request to an advertisement server for another advertisement associated with the contents of the third web page;
receiving a third advertisement from the advertisement server in response to the request; and
displaying the third advertisement in the toolbar display.

13. The method of claim 1 further comprising:
monitoring how long the first web page is displayed in the first area; and
displaying the first advertisement in the toolbar display only if the first web page is displayed in the first area for a predetermined period of time.

14. (canceled)

15. The method of claim 1 further comprising:
receiving a user-selection of an advertisement category;
transmitting the user-selected advertisement category with the request to the advertisement server for an advertisement associated with the contents of the first web page; and
thereby causing the first advertisement from the advertisement server to be selected from advertisements associated with the user-selected advertisement category.

16. The method of claim 15 wherein transmitting the user-selected advertisement category further comprises:
selecting, from the contents of the web page, one or more content keywords; and
transmitting a request to an advertisement server for an advertisement associated with the selected one or more content keywords and an advertisement category keyword corresponding to the user-selected advertisement category.

17. A system for displaying advertisements within a browser window comprising:
a browser application that retrieves source code and displays web pages within the browser window;
a toolbar application that generates a toolbar display within the browser window, wherein the toolbar application also searches retrieved source code and, based on the search, selects and transmits keywords to an advertisement server; and
wherein the toolbar application further receives advertisements associated with the keywords and displays the advertisements within the toolbar display.

18. The system of claim 17 wherein the toolbar display includes a first textbox for receiving a search term and a user control that, upon user selection, transmits a search request to a remote computing device.

19. The system of claim 17 further comprising:
an advertisement server that receives requests from the toolbar application and, based on the keywords in the request, selects at least one advertisement associated with the keywords for display in the toolbar display and transmits the advertisement to the toolbar application.

20-22. (canceled)

23. The system of claim 17 wherein the toolbar application searches the first web page by transmitting a search request to an advertisement engine; and wherein the advertisement engine receives the search request from the toolbar application and, in response, retrieves and searches a copy of the first web page, and selects the keywords.

24. The system of claim 23 wherein the advertisement engine further transmits the keywords to the advertisement server.

25. The system of claim 23 wherein the advertisement engine further transmits the keywords to the toolbar application for subsequent transmission to the advertisement server.

26. The system of claim 23 wherein the browser and toolbar application are located on a first computing device and the advertisement engine and advertisement server are located on one or more remote computing devices different from the first computing device.

27. The system of claim 26 wherein the toolbar application is associated with a remote service provided by a computing device different from the first computing device and includes at least one user-selectable control providing access to functions of the remote service.

28. The system of claim 27 wherein the remote service includes a search service and the toolbar display includes at least one user-selectable control for transmitting search requests directly to the search service.

29. (canceled)

30. The system of claim 17 wherein the toolbar display includes at least one user-selectable control through which the user may transmit an advertisement category selection to the advertisement server, thereby causing the advertisements received from the advertisement server to be limited to advertisements associated with the advertisement category selection.
